(19) United States
(12) Patent Application Publication
(10) Pub. No.: US 2013/0152217 A1
(43) Pub. Date: Jun. 13, 2013

(54) MACHINE-TO-MACHINE APPARATUS CAPABLE OF FACILITATING ADDITION OF EXTENSION FUNCTIONALITIES

(71) Applicant: Donghyun PARK, Daejeon (KR)

(72) Inventor: Donghyun PARK, Daejeon (KR)

(73) Assignee: JEONGWON TECHNOLOGY CO., LTD., Daejeon (KR)

(21) Appl. No.: 13/331,227

(22) Filed: Dec. 20, 2011

(30) Foreign Application Priority Data
Dec. 13, 2011 (KR) 10-2011-0133968

(51) Int. Cl. G06F 13/14; G06F 21/24

(52) U.S. Cl. 726/29; 710/74

(57) ABSTRACT

Disclosed is a Machine-To-Machine (M2M) apparatus capable of facilitating addition of extension functionalities. The apparatus includes an input/output unit configured to connect with an external peripheral, a wireless communication unit configured to connect with the external peripheral or a control center (server), a storage unit configured to store details about the exchange of data between the input/output unit and the wireless communication unit, programs of one or more inherent functionalities and scripts of one or more extension functionalities, Application Programming Interfaces (APIs) and libraries configured to be provided to obtain a command code of each of the extension functionalities from the script of the extension functionality, control means configured to verify a right to use to determine whether to execute the command code, and an interpreter configured to provide an environment in which command codes of the APIs and libraries are sequentially executed, and to add the extension functionality.

### BACKGROUND OF THE INVENTION

1. Field of the Invention

The present invention relates generally to a Machine-To-Machine (M2M) apparatus capable of facilitating the addition of extension functionalities depending on the user or field and, more particularly, to an M2M apparatus which is capable of easily adding and using necessary extension functionalities, other than the inherent functionalities, in a variety of fields according to user preferences.

2. Description of the Related Art

With the development of information and communication technology, a networking and Internet environment which is centered around computers, such as Personal Computers (PCs) and notebook computers, has been changing to an environment which includes computers and is focused on small-sized mobile devices, such as smart phones, Personal Digital Assistants (PDAs), and portable multimedia devices.

Small-sized devices capable of performing operation, communication and networking functionality may be attached not only to information devices but also to general objects, such as measuring devices, thermometers, etc. Such small-sized devices attached to the objects allow the information of the objects be automatically acquired, and enables the objects to share information over a communication network. The terms which are used to refer to the concepts of technology by which objects are connected to a network using communication devices attached to the objects or information is shared among objects over a communication network constructed among them encompass the Internet of Things (IoT), M2M and Object-To-Object (O2N) intelligent communication. In such a network environment, human-to-human, human-to-object and object-to-object communication networking is enabled, and therefore information can be shared among all objects, which is an essential technical component that is required for the evolution to the future ubiquitous information service society.

M2M is a technology in which information collected by objects called machines, such as devices or apparatuses, or the information of objects is collected in a server over a transmission network without human intervention, is processed, and is then provided to users.

That is, as illustrated in FIG. 1, an M2M apparatus 2 collects and processes data received from measuring devices 1, and transfers the processed data to a collecting and measuring device control apparatus 3. Alternatively, the M2M apparatus 2 may transfer unprocessed data to the collecting and measuring device control apparatus 3.

In the other direction, the M2M apparatus 2 analyzes data received from the collecting and measuring device control apparatus 3 and then controls the measuring devices. Alternatively, the M2M apparatus 2 may transfer unprocessed data to the measuring devices 1.

However, the conventional technology is problematic in that a user cannot directly add a necessary inherent functionally or in that it is difficult to add an extension functionality because developer-level professional knowledge is required owing to the complexity of the methods of adding.

Furthermore, the conventional technology is problematic in that even when some users have information which they do not want to divulge to the outside, such as a method of use or know-how, the implementation of a desired functionality should be entrusted to an M2M product provider because they cannot implement the desired functionality in the M2M apparatus, and therefore it is difficult to maintain such information secure.

### SUMMARY OF THE INVENTION

Accordingly, the present invention has been made keeping in mind the above problems occurring in the prior art, and an object of the present invention is to provide an M2M apparatus which enables extension functionalities to be easily added depending on the user or field by adding additional functions via wired and wireless connections.

Furthermore, another object of the present invention is to provide an M2M apparatus capable of facilitating the addition of extension functionalities depending on the user or field, in which in order to support the extension of functionalities, an existing system hands over a right to control to an extension portion after processing data, and therefore the extension portion can perform the functionalities.

Furthermore, still another object of the present invention is to provide an M2M apparatus capable of facilitating the addition of extension functionalities depending on the user or field, in which a communication functionality and functionalities required to maintain a basic system are hidden from the extension portion and therefore a user's independent space is provided.

The objects of the present invention are not limited to the above-described objects.

In order to accomplish the above objects, the present invention provides an M2M apparatus capable of facilitating addition of extension functionalities, including an input/output unit configured to connect with an external peripheral via a wired connection, and to receive a command or transfer data; a wireless communication unit configured to connect with the external peripheral or a control center (server) at a remote location via a wireless connection; a storage unit configured to store details about exchange of data between the input/output unit and the wireless communication unit, programs of one or more inherent functionalities and scripts of one or more extension functionalities; Application Programming Interfaces (APIs) and libraries stored in the storage unit, and configured to be provided to obtain command code of each of the extension functionalities from the script of the extension functionality which controls the external peripheral which is connected via the input/output unit or wireless communication unit; control means configured to verify a right to use by using license matching to determine whether to execute the command code; and an interpreter configured to be granted a right by the control means, to provide an environment in which command codes of the APIs and libraries are sequentially executed, and to add the extension functionality.

The storage unit may include a license storage space.

The control means may include a license management unit, and the license management unit may receive a license key formed using a preset ID of a wireless communication modem received via the wireless communication unit and an ID of the wireless communication modem stored in the license storage space and determine whether the interpreter has been granted the right.

The license key and the ID of the wireless communication modem may be encrypted and transferred to the license management unit, and the license key may be formed by combining the ID of the modem, an ID of a program provider, and an expiration date.

The script may be input via a terminal connected to the input/output unit or the wireless communication unit.

The storage unit may store one or more administrator's additional functionality programs provided by one or more program providers.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the typical relationship between an M2M apparatus and related devices (or apparatuses);

FIG. 2 is a conceptual diagram illustrating an M2M apparatus capable of facilitating the addition of extension functionalities according to an embodiment of the present invention;

FIG. 3 is a diagram illustrating a storage unit of the M2M apparatus capable of facilitating addition of extension functionalities according to an embodiment of the present invention; and

FIG. 4 is a diagram illustrating the granting of a license right by the control means of the M2M apparatus capable of facilitating addition of extension functionalities according to an embodiment of the present invention.

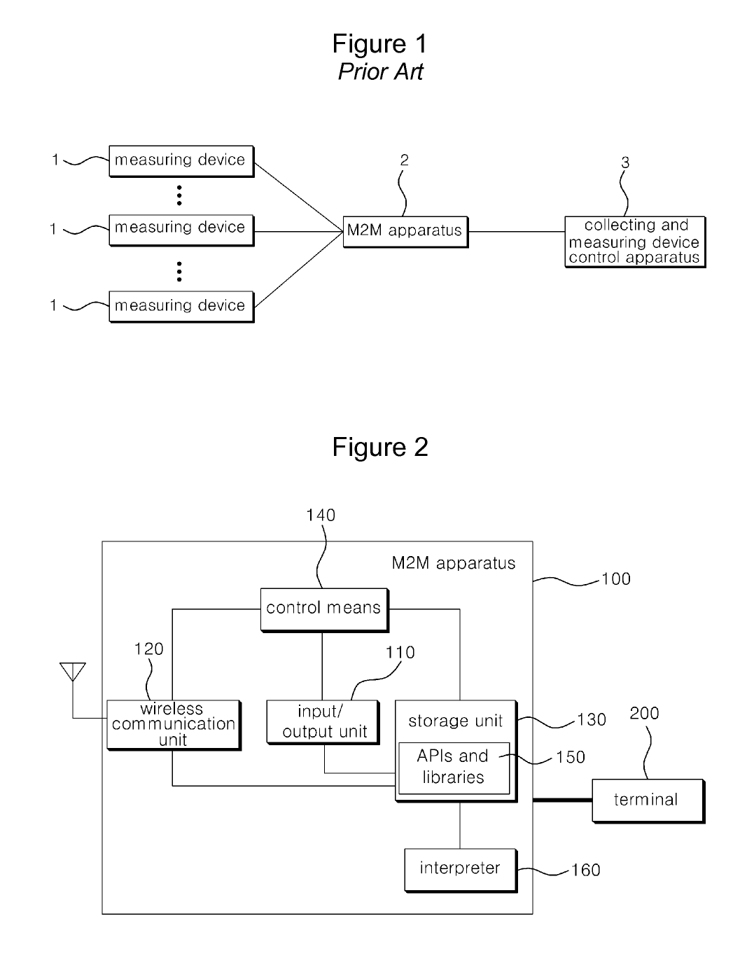

### DESCRIPTION OF THE PREFERRED EMBODIMENTS

Reference now should be made to the different drawings throughout which the same reference numerals are used to designate the same or similar components.

Preferred embodiments of the present invention will be described in detail with reference to the accompanying drawings. The same reference numerals will be used for the same components wherever possible in the drawings. Furthermore, descriptions of well-known functions and configurations which may make the gist of the present invention unnecessarily obscure will be omitted.

FIG. 2 is a conceptual diagram illustrating an M2M apparatus 100 capable of facilitating the addition of extension functionalities according to an embodiment of the present invention. The M2M apparatus 100 includes an input/output unit 110, a wireless communication unit 120, a storage unit 130, control means 140, APIs and libraries 150, and an interpreter 160. Although a terminal does not belong to the M2M apparatus 100, it will also be described to further the understanding of the present invention.

The input/output (I/O) unit 110 connects with an external peripheral in a wired fashion, and then receives a command or transfers data. Here, the input/output unit 110 may be referred to as a wired connection unit.

The external peripheral which is connected to the input/output unit 110 is a device which extracts signals and includes a configuration required in the technical field of the M2M apparatus, such as a thermometer, a water level regulator, a voltage meter, a camera, a motor control switch, or a lighting switch. The external peripheral with which the input/output unit 110 connects is not limited only to the above-described external peripherals.

The wireless communication unit 120 wirelessly connects with wireless external peripheral or a control center (server) at a remote location. In this case, the wireless communication unit 120 may utilize a variety of wireless technologies such as WiFi, 3G HSPA, LTE, Bluetooth, and ZigBee.

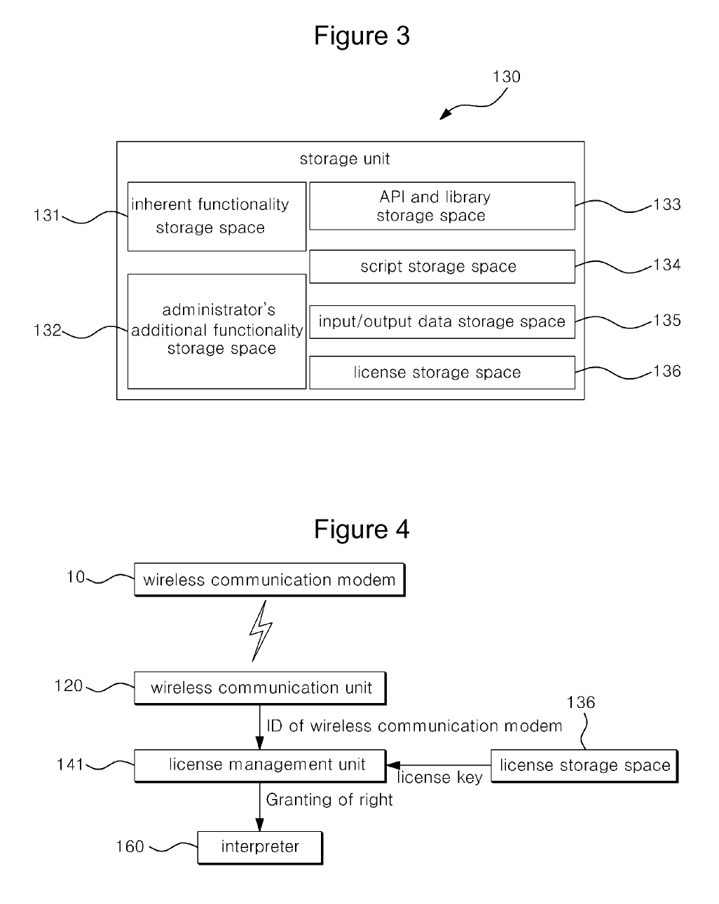

The storage unit 130 stores details about the exchange of data between the input/output unit 110 and the wireless communication unit 120 and the scripts of additional functionalities. Here, the assignment of the storage unit 130 may be performed, as illustrated in FIG. 3.

The storage unit 130 may be divided into an inherent functionality storage space 131 required to perform the inherent functionalities of the M2M apparatus 100, an administrator's additional functionality storage space 132, and storage spaces 133, 134, 135 and 136 required to perform extension functionalities. Here, the administrator's additional functionality storage space 132 is assigned to the provider of the M2M apparatus 100 or a program provider, and may be used to support functionalities to be updated, which are other than the inherent functionalities.

It is preferred that the inherent functionality storage space 131 and the administrator's additional functionality storage space 132 be separate from the storage space 133, 134, 135 and 136 required to perform extension functionalities so as to prevent access via the user terminal.

The storage spaces required to perform the extension functionalities are divided into an API and library storage space 133, a script storage space 134, an input/output data storage space 135, and a license storage space 136 required to manage the rights of the extension functionalities of the M2M apparatus 100.

The API and library storage space 133 stores APIs and libraries 150 which convert input scripts into command code.

The script storage space 134 stores scripts which are input via the terminal for the sake of user convenience. Such a script may later be means for operating an additional functionality.

The input/output data storage space 135 stores data which is input and output via the M2M apparatus.

Furthermore, the license storage space 136 stores a license key which is assigned by the provider of the M2M apparatus or the program provider.

The APIs and libraries 150 are stored in the API and library storage space 133 of the storage unit 130, and are provided to obtain the command codes of the extension functionalities from the scripts of additional functionalities which control external peripherals which are connected via the input/output unit 110 and the wireless communication unit 120.

The control means 140 controls the functionalities of the input/output unit 110, the wireless communication unit 120, and the storage unit 130, and verifies the right of use using license matching to check whether to execute the command code of each extension functionality.

FIG. 4 illustrates the granting of a right by the license management unit.

The control means 140 includes a license management unit 141. The license management unit 141 receives a license key which was formed using the preset ID of a wireless communication modem 10 received via the wireless communication unit 120 and the ID of the wireless communication modem 10 stored in the license storage space 136, and determines whether the interpreter 160 has been granted a right for an extension program.

Here, the license key and the ID of the wireless communication modem 10 are encrypted and then transferred to the license management unit 141. The license key is formed by combining the ID of the wireless communication modem 10, the ID of the program provider, and an expiration date.

Here, the expiration date of the license key is a date that is designated or contracted for the provision of the M2M apparatus. When there is no designated or contracted date, the expiration date may be preferably omitted and some other additional item may be added.

The interpreter 160 provides an environment in which the command codes of APIs and libraries 150 are sequentially performed, and an input command code is immediately interpreted and then executed, thereby causing the M2M apparatus 100 to perform the extension functionality. In this case, the interpreter 160 does not create a program, and enables the operation of an extension functionality to be performed based on a script.

Furthermore, the interpreter 160 protects the system by preventing reads and writes from being performed on areas other than the storage spaces 133, 134, 135 and 136 required to perform the extension functionalities of the storage unit 130.

Although the terminal 200 is not a part of the M2M apparatus 100, it may be used as input means for adding extension functionalities by inputting scripts to the M2M apparatus 100. In this case, a Personal Computer (PC) may be chiefly used as the terminal 200, and the terminal 200 may be connected to the input/output unit 110 of the M2M apparatus 100 using RS-232 or USB, or via a wireless connection. Here, the protocol used to connect with the input/output unit 100 is not limited.

Furthermore, each script input via the terminal 200 may be suitable for the user or a field of application.

A method of adding an extension functionality to the M2M apparatus 100 configured as described above includes connecting the terminal 200 to the M2M apparatus 100 and inputting a script based on the extension functionality. This has the advantage of preventing know-how from being divulged to the outside by enabling the user to input the script which contains the necessary extension functionality.

Thereafter, the script input via the terminal 200 creates the command code of the extension functionality using the APIs and libraries 150.

Finally, when the created command code of the extension functionality is input, it is immediately interpreted by the interpreter 160 and therefore the extension functionality can be performed. At this time, the interpreter 160 should be granted the right to interpret the command code in real time by the license management unit 141 of the control means.

Granting the right enables whether the expiration date of the corresponding user is over, and prevents an authorized person from causing a system error.

In this case, errors are prevented from occurring by prohibiting access to communication functionality using the terminal 200 and the inherent functionalities of the M2M apparatus.

As described above, the present invention is advantageous in that a user can easily add extension functionalities using a basic operation method without complicated knowledge being required.

Furthermore, the present invention has the advantage of reducing the personal expenses because extension functionalities can be easily added using a reduced amount of manpower.

Furthermore, the present invention has the advantage of reducing the number of devices that perform functionalities because the extension functionalities can be appropriately added depending on the user and the field.

Furthermore, the present invention has the advantage of providing security for technical know-how related to the control of a user's M2M apparatus and data processing.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A Machine-To-Machine (M2M) apparatus capable of facilitating addition of extension functionalities, comprising:
an input/output unit configured to connect with an external peripheral via a wired connection, and to receive a command or transfer data;
a wireless communication unit configured to connect with the external peripheral or a control center (server) at a remote location via a wireless connection;
a storage unit configured to store details about exchange of data between the input/output unit and the wireless communication unit, programs of one or more inherent functionalities and scripts of one or more extension functionalities;
Application Programming Interfaces (APIs) and libraries stored in the storage unit, and configured to be provided to obtain command code of each of the extension functionalities from the script of the extension functionality which controls the external peripheral which is connected via the input/output unit or wireless communication unit;
control means configured to verify a right to use by using license matching to determine whether to execute the command code; and
an interpreter configured to be granted a right by the control means, to provide an environment in which command codes of the APIs and libraries are sequentially executed, and to add the extension functionality.

2. The M2M apparatus as set forth in claim 1, wherein the storage unit comprises a license storage space.

3. The M2M apparatus as set forth in claim 1, wherein the control means comprises a license management unit, and the license management unit receives a license key formed using a preset ID of a wireless communication modem received via the wireless communication unit and an ID of the wireless communication modem stored in the license storage space and determines whether the interpreter has been granted the right.

4. The M2M apparatus as set forth in claim 3, wherein the license key and the ID of the wireless communication modem are encrypted and transferred to the license management unit, and the license key is formed by combining the ID of the modem, an ID of a program provider, and an expiration date.

5. The M2M apparatus as set forth in claim 1, wherein the script is input via a terminal connected to the input/output unit or the wireless communication unit.

6. The M2M apparatus as set forth in claim 1, wherein the storage unit stores one or more administrator's additional functionality programs provided by one or more program providers.
